(19) United States
(12) Patent Application Publication
(10) Pub. No.: US 2005/0131089 A1
(43) Pub. Date: Jun. 16, 2005

(54) Hydrocarbon copolymer or polymer based aerogel and method for the preparation thereof

(75) Inventors: Laurent Kocon, Artannes sur Indre (FR); Laurent Wiezorek, Ville D'Avray (FR)

Correspondence Address: Burns Doane Swecker & Mathis, 1737 King Street # 400, Alexandria, VA, 22314-2727, US

(73) Assignee: Commissariat A L'Energie Atomique, Paris (FR)

(21) Appl. No.: 10/508,116

(22) PCT Filed: Mar. 18, 2003
(86) PCT No.: PCT/FR03/00857

(30) Foreign Application Priority Data
Mar. 20, 2002 (FR) 02/03462

(51) Int. Cl. C08J 9/00

(52) U.S. Cl. 521/50

(57) ABSTRACT

The present invention relates to aerogels based on a polymer obtained by polymerization of at least one aliphatic or aromatic hydrocarbonaceous monomer optionally substituted by one or more halogen atoms which comprises at least two ethylenic functional groups or based on a copolymer obtained by polymerization of at least one monomer having a definition identical to that given above with at least one comonomer which can be polymerized with the said monomer. The invention also relates to a process for the preparation of the said aerogels. Application of the said aerogels in the fields of acoustic or thermal insulation and of microporous membranes.

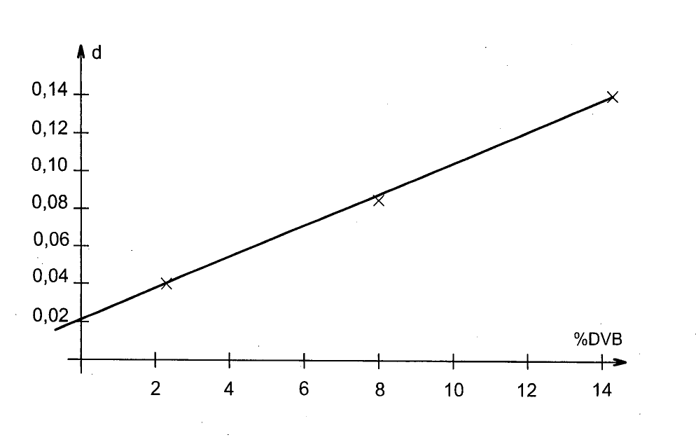

### TECHNICAL FIELD

The subject-matter of the present invention is organic aerogels obtained in particular from hydrocarbonaceous monomers having ethylenic functional groups and a process for the preparation of these.

The field of the invention is thus that of aerogels.

Aerogels commonly denote low-density microcellular materials exhibiting a continuous porosity, a pore size which can be less than 50 nm and a very high specific surface which can be of the order of 400 to 1000 m²/g. For this reason, aerogels are applied in numerous fields.

Thus, in the field of acoustics or the science of heat, aerogels can be used as insulating materials, insofar as the size of the constituent pores of the aerogels is sufficiently low to trap the air molecules and the porosity is sufficiently high to confine a significant amount of the said molecules.

### STATE OF THE ART

Because of their many applications, aerogels have formed the subject of numerous developments in the prior art.

The most commonly used aerogels are silica-based aerogels prepared by a sol-gel process successively comprising a step of hydrolysis followed by a condensation of silicon precursors, such as tetramethoxysilane or tetraethoxysilane, and of a step of drying the alcogel carried out under conditions such that the fractal structure of the gel can be retained on conclusion of the drying.

Other aerogels have been developed, in particular organic aerogels resulting from monomers commonly used in the synthesis of “thermosetting” plastics.

Thus, U.S. Pat. No. 4,997,804 [1] discloses a process for the synthesis of aerogels which is derived directly from the chemistry of phenoplasts, the said process comprising a step of polycondensation of polyhydroxybenzenes, such as resorcinol, with formaldehyde, followed by a solvent exchange in order to replace the original solvent, generally water, by a solvent which is miscible with CO₂, which constitutes an essential condition for subsequently carrying out supercritical drying with CO₂.

The publication “Melamine-Formaldehyde Aerogels”, Polym. Prepr., 32 (1991), 242, [2] describes the production of aerogels by polycondensation of formaldehyde and melamine.

Finally, U.S. Pat. No. 5,990,184 [3] and Patent Applications WO 95/03358 [4], WO 96/36654 [5] and WO 96/37539 [6] report methods for the preparation of aerogels by polymerization of isocyanates.

However, the aerogels of the prior art all exhibit one or more of the following disadvantages:
they constitute relatively hydrophilic aerogels owing to the fact that the starting precursors or monomers are relatively polar. In particular, the aerogels of phenoplast type are synthesized in a solvent which is immiscible with CO₂, which requires an additional step of solvent exchange;
they are prepared from precursors whose corresponding polymers exhibit thermal conductivities which are greater than those of hydrocarbonaceous polymers, such as polystyrene, between 0.3 and 0.7 W.m⁻¹.K⁻¹ for phenoplasts, of the order of 0.25 W.m⁻¹.K⁻¹ for polyurethanes, whereas the thermal conductivity of polymers such as polystyrene is generally between 0.12 and 0.18 W.m⁻¹K⁻¹.

### ACCOUNT OF THE INVENTION

The aim of the present invention is to provide novel polymer- or copolymer-based aerogels obtained by polymerization of essentially hydrocarbonaceous monomers which do not exhibit the abovementioned disadvantages and which in particular simultaneously combine the properties related to the intrinsic characteristics of the polymer or copolymer and those related to the aerogel texture of the said polymer or copolymer.

The aim of the present invention is also to provide processes for the preparation of such aerogels.

According to a first subject-matter, the aim of the present invention is an aerogel based on a polymer obtained by polymerization of at least one aliphatic or aromatic hydrocarbonaceous monomer optionally substituted by one or more halogen atoms, the said monomer comprising at least two ethylenic functional groups.

According to a second subject-matter, the aim of the present invention is an aerogel based on a copolymer obtained by polymerization of at least one aliphatic or aromatic hydrocarbonaceous monomer optionally substituted by one or more halogen atoms, the said monomer comprising at least two ethylenic functional groups, and of at least one comonomer which can be polymerized with the said monomer.

According to the invention, the aliphatic hydrocarbonaceous monomer or monomers comprising at least two ethylenic functional groups can be chosen from the group of compounds consisting of butadiene, isoprene, pentadiene, hexadiene, methylpentadiene, cyclohexadiene, heptadiene, methylhexadiene, 1,3,5-hexatriene and the mixtures of these, the said compounds optionally being substituted by one or more halogen atoms, such as chlorine, bromine or iodine.

Preferably, the hydrocarbonaceous monomer(s) comprising at least two ethylenic functional groups is (are) (an) aromatic monomer(s) optionally substituted by one or more halogen atoms, such as chlorine, bromine or iodine. More preferably still, the aromatic monomers are styrene monomers comprising at least two ethylenic functional groups chosen, for example, from the meta or para isomers of divinylbenzene, trivinylbenzene and the mixtures of these.

It is specified that the term “meta or para isomers of divinylbenzene” and the term “trivinylbenzene” are understood to mean the compounds corresponding to the following formulae:

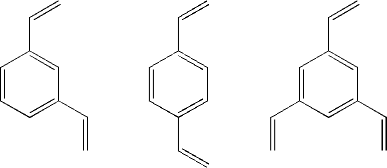

Aerogels which can exhibit excellent thermal insulation properties are thus obtained with hydrocarbonaceous monomers as defined above owing to the fact that the constituent organic polymer of the aerogel exhibits a very good thermal conductivity which can be of the order of 0.12 to 0.18 W.m⁻¹.K⁻¹and that the structure of aerogel type is particularly suitable for the nonpropagation of heat.

Furthermore, by virtue of the strongly hydrophobic nature of such aerogels, applications as microporous membranes can also be envisaged with these aerogels.

As regards the aerogel of the second subject-matter, the comonomer can be chosen from the group consisting of styrene, α-methylstyrene, ethylstyrene, maleic anhydride, acrylonitrile, acrylic esters and the mixtures of these.

These comonomers can thus contribute to modifying the intrinsic properties or texture of the solid network which constitutes the skeleton of the aerogel.

For the aerogels of the invention, it is possible to envisage the presence of at least one of the following additives chosen from inorganic or organic fibres, foams or polymers, such as polybutadiene.

Mention may be made, for example, as inorganic fibres, of glass or carbon fibres and, as organic fibres, of nylon or rayon fibres, it being possible for these fibres to fulfil the role of reinforcing compounds for the aerogel.

It is specified that, according to the invention, the term “foam” is understood to mean an organic material, the solid matter of which encloses a large number of cavities with small diameters. Mention may be made, as foam, by way of examples, of polyurethane foams.

The presence of additives in the aerogels of the invention can contribute to modifying certain optical, thermal, dielectric or mechanical macroscopic properties of the aerogel. Thus, the addition of fibres makes it possible to improve the mechanical properties of the aerogel and carbon powder, as opacifying agent, can modify the radiative conductivity of the aerogel, indeed even its dielectric properties, as a result of its electrical conductivity.

The aerogels according to the invention generally exist in the form of white-coloured opaque materials. The texture of the said aerogels can be colloidal in nature with particle sizes which can range from 5 to 100 nanometres and pore sizes from 1 nanometre to 1 micrometre. Furthermore, the aerogels of the invention can exhibit high specific surfaces ranging from 100 to 1500 m²/g.

Another aim of the present invention is to provide a process for the preparation of the aerogels described above.

Thus, the process for the preparation of aerogels according to the invention comprises the sequence of following stages:
a) formation of a gel by polymerization in at least one organic solvent of one or more monomers as defined above and optionally of one or more comonomers as defined above; and
b) drying the gel obtained in a) under supercritical conditions.

According to the invention, the organic solvent or solvents used in step a) are advantageously solvents which make possible the dissolution of the monomers and of the optional comonomers.

According to the invention, in step a), the monomer or monomers and the optional comonomer or comonomers are advantageously present in a proportion of 0.5 to 50% by weight with respect to the weight of the organic solvent or solvents used in step a), with preferably from 1 to 20%, which makes possible access to aerogels having a density of between 0.02 and 0.5.

Advantageously, the polymerization envisaged during step a) to form the gel is a radical polymerization.

The initiation of this type of polymerization in the liquid medium can be envisaged in various ways, in particular by self-initiation.

However, according to the process of the invention, the radical polymerization reaction is preferably initiated by addition, during step a), of at least one chemical initiator.

For example, a chemical initiator which is effective in the context of this invention can be an initiator chosen from the group consisting of azobisisobutyronitrile, benzoyl, acetyl, cumyl, t-butyl and lauryl peroxide, t-butyl hydroperoxide, t-butyl peracetate and the mixtures of these.

The radical polymerization is preferably carried out at a temperature which is effective in bringing about the thermal decomposition of the chemical initiator.

In the process according to the invention, the choice of the solvent and of the optional initiator, of the concentrations of monomers, which concentrations have already been explained above, of the concentrations of initiator and of the temperature used for the polymerization are significant parameters as they act directly on the texture of the aerogel obtained.

The combination of these parameters can be determined by tests accessible to a person skilled in the art according to the constituents used in step a).

The proportion of initiator can be determined not according to the number of moles of monomers or comonomers but according to the total number of moles of ethylenic functional groups introduced by the monomers or comonomers, it being possible for some actually to comprise three ethylenic functional groups (for example, trivinylbenzene) or two, such as divinylbenzene, indeed even a single ethylenic functional group, such as styrene (fulfilling the role of comonomer).

According to the invention, the initiator is advantageously present in a proportion of 5×10⁻⁴ to 0.5 in molar proportion with respect to the number of moles of ethylenic functional groups of the monomer(s) and optionally of the comonomer(s).

However, this content depends on the monomers present in step a) and on the temperature. The optimum value can be determined by a person skilled in the art, it being understood that excessively low or excessively high values can be harmful to good gel setting. Thus, on using, for example, in stage a), divinylbenzene as monomer, AIBN as chemical initiator and toluene as solvent, the Inventors have observed, with a percentage of monomer of 2% at 85° C, the appearance of a gelling precipitate for proportions of initiator of less than 2×10⁻³. In this same system, with a percentage of precursor of 1%, no gelling could be observed with a proportion of initiator of 0.6, whereas it is effective at 0.13.

As regards the temperature, in the case of the use of a chemical initiator for initiating the polymerization reaction, the temperature should preferably make possible the thermal decomposition of the initiator, for example according to kinetics corresponding to a dissociation rate constant kd generally of between 10⁻⁶ and 5×10⁻³ S⁻¹ with, in the case of AIBN, a preference for values ranging from 3×10⁻⁵ S⁻¹, for a temperature of 70° C., to 10⁻³ S⁻¹, for a temperature of 100° C.

By way of examples, the temperature ranges recommended for initiators which can be envisaged in carrying out the process according to the invention are set out in Table 1.

TABLE 1

| Initiator | Temperature range |
|---|---|
| Acetyl peroxide | 50° C. < T < 115° C. |
| Benzoyl peroxide | 50° C. < T < 130° C. |
| Cumyl peroxide | 95° C. < T < 160° C. |
| t-Butyl peroxide | 100° C. < T < 185° C. |
| t-Butyl hydroperoxide | 140° C. < T < 230° C. |

For example, when the polymerization is carried out solely in the presence of para-divinylbenzene in the presence of a chemical initiator, step a) of the process, corresponding to the setting of the gel according to the invention, can take place according to the sequence of following reactions:
a decomposition reaction of the initiator, written A₂, to primary radicals A⁻:
   A₂→2A⁻
an initiation reaction by formation of radicals from the para isomer of divinylbenzene: 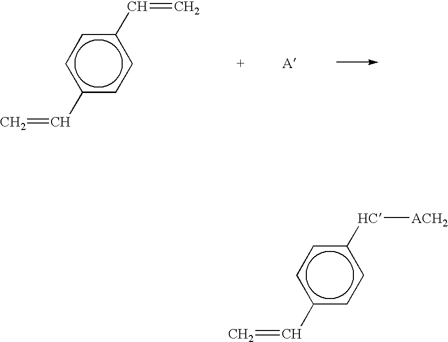
a propagation reaction, which results in the formation of a solid network: 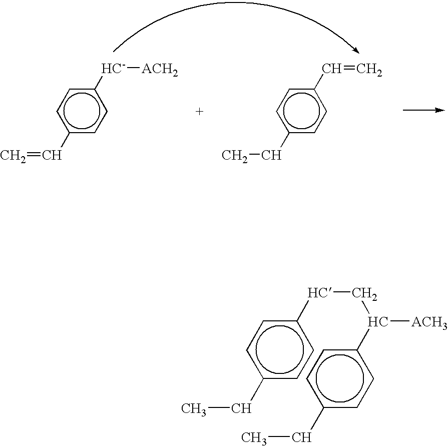
a termination reaction, which results in the disappearance of the radical reactive sites situated on the molecules:

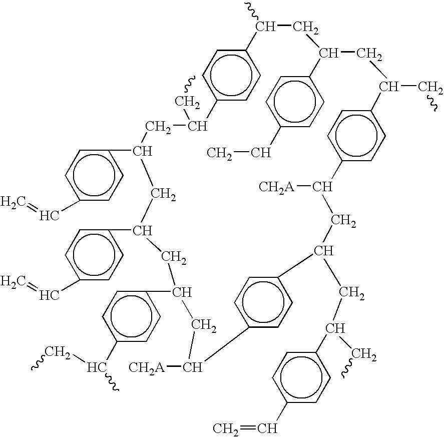

On conclusion of this step a), clarified above with the example of divinylbenzene, an organic gel of covalent nature is formed which exists in the form of a three-dimensional solid network which occupies the entire volume of the solution and, for this reason, confines the solvent despite the open nature of the porosity. This is because the size of the cells delimited by the three-dimensional solid network is sufficiently small for the solvent to remain within the network by a simple capillary effect.

The second step of the process according to the invention consists in drying the gel obtained during stage a) without damaging the solid network.

According to the invention, this step is carried out under supercritical conditions, the said supercritical conditions preferably being produced with supercritical carbon dioxide.

In this case, the organic solvent or solvents used in step a) are miscible with carbon dioxide. Thus, during the drying of the gel by supercritical carbon dioxide, solvents of this type make possible direct exchange with carbon dioxide without passing through an intermediate stage of exchange of the solvent or solvents used in step a) with a solvent which is miscible with carbon dioxide.

Such solvents can be chosen from aliphatic hydrocarbons, such as hexane, heptane or cyclohexane, aromatic hydrocarbons, such as benzene, ethylbenzene, isopropylbenzene, t-butylbenzene or toluene, ketones, such as acetone, aldehydes, alcohols, such as butanol, ethers, such as ethyl ether, esters, optionally halogenated carboxylic acids, such as acetic acid, and the mixtures of these.

According to this preferred embodiment, this step of drying with supercritical carbon dioxide advantageously comprises, in succession, the following operations:
exchange of the organic solvent or solvents present in the gel prepared in a) with liquid or supercritical CO₂; and
extraction of the CO₂ by application of a temperature and of a pressure which are substantially greater than the critical point of CO₂.

The supercritical drying step is generally carried out in an autoclave. In the context of this drying, the solvent exchange operation can be carried out continuously or by successively filling and emptying the autoclave. The following operation, consisting in extracting the CO₂ introduced previously, can consist, according to the invention, in heating and pressurizing the autoclave in order to exceed the critical point of the CO₂, that is to say a temperature and a pressure respectively greater than 31.1° C. and than 7.3 MPa. These conditions being reached, the autoclave is slowly depressurized at constant temperature in order to avoid any phenomenon of turbulence and of excessive pressure inside the material which might result in fracturing of the constituent solid network of the gel. Finally, when the autoclave is at ambient pressure, it is cooled to ambient temperature.

Finally, the aerogels according to the invention can be used in numerous applications and in particular in thermally or acoustically insulating materials.

The aerogels according to the invention can also be used in microporous membranes as a result of the hydrophobic nature of the monomers used.

The invention will now be described in the light of the following examples, given, of course, by way of illustration and without implied limitation.

### BRIEF DESCRIPTION OF THE FIGURE

The single figure is a graph representing the relationship between the final density d of the aerogel obtained by polymerization of the para isomer of divinylbenzene and the percentage by mass of the said divinylbenzene in the reaction medium (% DVB).

### DETAILED ACCOUNT OF SPECIFIC EMBODIMENTS

The examples which follow illustrate the preparation of aerogels according to the invention with, as starting reactants:
technical divinylbenzene from Aldrich, 80% pure (corresponding to the para isomer), comprising ethylstyrene and 1000 ppm of p-tert-butylcatechol;
azobisisobutyronitrile or AIBN from Merck, with a purity of greater than 98%; and
toluene, distilled beforehand before use.

The specific surfaces of the aerogels obtained, in the context of these examples, are obtained using a Quantochrome Monosorb BET device by dynamic single-point measurement on a nitrogen/helium mixture.

### EXAMPLE 1

0.02 g of AIBN is introduced with stirring into a receptacle containing toluene. After complete dissolution of the initiator, 6.8 ml of divinylbenzene are added to the solution, still with stirring. The total volume of toluene in the solution is 43.1 ml. The percentage by weight of divinylbenzene in solution is 14.3%. The proportion of initiator with respect to the number of ethylenic functional groups is 0.0014. These operations are carried out at ambient temperature, in order not to bring about self-initiation of the reaction and thermal decomposition of the initiator.

The solution is subsequently decanted into glass moulds. The latter are subsequently placed in an automatically-controlled heating/cooling bath at 85° C. in order to initiate the gelling. The material obtained after gelling and then supercritical drying is an aerogel with a density of between 0.14 and 0.15. The specific surface is estimated at 850 m²/g. The texture is of colloidal type.

### EXAMPLE 2

In this example, the divinylbenzene is purified in order to remove the p-tert-butylcatechol, which acts as polymerization inhibitor.

0.0028 g of AIBN is added with stirring to a receptacle containing 5 ml of toluene. After complete dissolution of the initiator, 0.241 ml of divinyl-benzene is added to the solution, still with stirring, and the solution is made up with the remaining volume of solvent, the total volume of solvent being 10.76 ml. The percentage by weight of divinylbenzene in solution is 2.3%. The proportion of initiator with respect to the number of ethylenic functional groups is 0.00558.

These operations are carried out at ambient temperature, for the same reasons as those put forward in Example 1. The solution is decanted into glass moulds. The latter are subsequently placed in an automatically-controlled heating/cooling bath at 85° C. The material obtained after gelling and then supercritical drying is a divinylbenzene aerogel with a density of 0.04. The specific surface measured is estimated at 1000 m²/g. The texture is of colloidal type.

### EXAMPLE 3

In this example, the divinylbenzene is purified in order to remove the p-tert-butylcatechol, which acts as polymerization inhibitor.

0.0996 g of AIBN is introduced with stirring into a receptacle containing toluene. After complete dissolution of the initiator, 2.68 ml of divinylbenzene are added to the solution, still with stirring, and the solution is made up with the remaining volume of solvent, it being known that the total volume of solvent is 32.32 ml. The percentage by weight of divinylbenzene in solution is 8%. The proportion of initiator with respect to the number of ethylenic functional groups is 0.0179. These operations are carried out at ambient temperature, for the same reasons as those put forward in Example 1. The solution is subsequently decanted into glass moulds. The latter are subsequently placed in an automatically-controlled heating/cooling bath at 75° C. The material obtained after gelling and then supercritical drying is an aerogel with a density of 0.085. The specific surface is estimated at 1000 m²/g.

The three examples demonstrate a direct correlation of linear type between the percentage by mass of divinylbenzene in the solution and the final density of the aerogel.

Thus, in the region studied, the following relationship, for example, exists:
d≈0.0083*(% by mass of divinylbenzene)+0.02

The values for final density d of the aerogel as a function of the percentage by mass of divinylbenzene, for the three examples displayed above, are listed in Table 2 below.

TABLE 2

| | Example | | |
|---|---|---|---|
| | 1 | 2 | 3 |
| % by mass of | 14.3 | 8 | 2.3 |
| divinylbenzene | | | |
| Final density | 0.14 | 0.085 | 0.04 |
| of the aerogel | | | |

The intermediate densities are therefore accessible simply by varying the percentage by mass of divinylbenzene.

The curve represented in the single figure demonstrates the linear relationship between final density d of the aerogel and the percentage by mass of divinylbenzene in the reaction medium.

Furthermore, the amount of initiator appears to have an influence, in the present invention, on the specific surface of the material. This is because the greater the number of moles of initiator, the greater the number of reaction sites. This results in an increase in the number of particles at the expense of their size, hence the increase in the specific surface.

Table 3 below, which lists, for the three examples displayed above, the values of ratio of the number of moles of initiator AIBN to the number of moles of ethylenic functional groups of the divinylbenzene (nAIBN/nC=C) and the specific surface of the aerogels obtained, illustrates the comment made above:

TABLE 3

| | Example | | |
|---|---|---|---|
| | 1 | 2 | 3 |
| nAIBN/nC = C | 0.0014 | 0.00558 | 0.0179 |
| Specific | 850 | 1000 | 1000 |
| surface | | | |
| (in m²/g) | | | |

### References Cited

[1] U.S. Pat. No. 4,997,804.
[2] “Melamine-Formaldehyde Aerogels”, Polym. Prepr., 32 (1991), 242.
[3] U.S. Pat. No. 5,990,184.
[4] WO 995/03358.
[5] WO 96/36654.
[6] WO 96/37539.

1-23. (canceled)

24. Aerogel based on a polymer obtained by polymerization of at least one aliphatic or aromatic hydrocarbonaceous monomer optionally substituted by one or more halogen atoms, the said monomer comprising at least two ethylenic functional groups.

25. Aerogel based on a copolymer obtained by polymerization of at least one aliphatic or aromatic hydrocarbonaceous monomer optionally substituted by one or more halogen atoms, the said monomer comprising at least two ethylenic functional groups, and of at least one comonomer which can be polymerized with the said monomer.

26. Aerogel according to claim 25, for which the comonomer is chosen from styrene, α-methylstyrene, ethylstyrene, maleic anhydride, acrylonitrile, acrylic esters and the mixtures of these.

27. Aerogel according to claim 24, for which the hydrocarbonaceous monomer(s) comprising at least two ethylenic functional groups is (are) an aromatic monomer.

28. Aerogel according to claim 27, for which the aromatic monomer is a styrene monomer.

29. Aerogel according to claim 28, for which the styrene monomer is chosen from the meta or para isomers of divinylbenzene, trivinylbenzene and the mixtures of these.

30. Aerogel according to claim 24, additionally comprising at least one of the following additives chosen from inorganic or organic fibres, foams or polymers, such as polybutadiene.

31. Aerogel according to claim 24, exhibiting a specific surface of 100 to 1500 m²/g.

32. Aerogel according to claim 24, exhibiting a pore size from 1 nanometre to 1 micrometre.

33. Process for the preparation of an aerogel according to claim 24, comprising the sequence of following stages:
a) formation of a gel by polymerization in at least one organic solvent of one of more monomers and optionally of one or more comonomers; and
b) drying the gel obtained in a) under supercritical conditions.

34. Preparation process according to claim 33, in which the monomer or monomers and the optional comonomer or comonomers are present, in step a), in a proportion of 0.5 to 50% by weight with respect to the weight of the organic solvent or solvents used in step a).

35. Preparation process according to claim 33, in which the monomer or monomers and the optional comonomer or comonomers are present, in step a), in a proportion of 1 to 20% by weight with respect to the weight of the organic solvent or solvents used in step a).

36. Preparation process according to claim 33, for which the polymerization is a radical polymerization.

37. Preparation process according to claim 36, in which the radical polymerization is initiated by addition, during step a), of at least one chemical initiator.

38. Preparation process according to claim 37, in which the chemical initiator is chosen from azobisisobutyronitrile, benzoyl, acetyl, cumyl, t-butyl and lauryl peroxide, t-butyl hydroperoxide, t-butyl peracetate and the mixtures of these.

39. Preparation process according to claim 36, in which the chemical initiator is present in a proportion of 5×10⁻⁴ to 0.5 in molar proportion with respect to the number of moles of ethylenic functional groups of the monomer(s) and optionally of the comonomer(s).

40. Preparation process according to claim 37, in which the radical polymerization is carried out at a temperature which is effective in bringing about the thermal decomposition of the chemical initiator.

41. Preparation process according to claim 33, in which the supercritical conditions, during the drying of step b), are produced by supercritical carbon dioxide.

42. Preparation process according to claim 41, in which the organic solvent or solvents of step a) are miscible with carbon dioxide.

43. Preparation process according to claim 42, in which the organic solvent or solvents of step a) are chosen from aliphatic hydrocarbons, such as hexane, heptane or cyclohexane, aromatic hydrocarbons, such as benzene, ethylbenzene, isopropylbenzene, t-butylbenzene or toluene, ketones, such as acetone, aldehydes, alcohols, such as butanol, ethers, such as ethyl ether, esters, optionally halogenated carboxylic acids, such as acetic acid, and the mixtures of these.

44. Preparation process according to claim 41, in which the drying by supercritical CO₂ comprises, in succession, the following steps:
exchange of the organic solvent or solvents present in the gel prepared in a) with liquid or supercritical CO₂
extraction of the CO₂ by application of a temperature and of a pressure which are substantially greater than the critical point of CO₂.

45. Thermally or acoustically insulating material comprising an aerogel according to claim 24.

46. Microporous membrane comprising an aerogel according to claim 24.
